(19) United States
(12) Patent Application Publication
(10) Pub. No.: US 2011/0168949 A1
(43) Pub. Date: Jul. 14, 2011

(54) METHOD FOR PRESERVING OBJECTS CONTAINING PIGMENT

(76) Inventors: Stephen Hackney, Nr Guildford (GB); Joyce Townsend, London (GB); Jacob Llewellyn Thomas, London (GB); Andrew Lerwill, Barnstaple (GB)

(21) Appl. No.: 13/063,338

(22) PCT Filed: Sep. 11, 2009
(86) PCT No.: PCT/GB2009/002192

§ 371 Date: Mar. 10, 2011

(30) Foreign Application Priority Data
Sep. 12, 2008 (GB) 0816756.1

(51) Int. Cl. C09K 15/06; C01C 3/12; C09K 15/02

(52) U.S. Cl. 252/400.53; 423/265; 252/397

(57) ABSTRACT

The present invention is directed towards a method of preserving an object comprising Prussian blue pigment and a storage and/or display case for said preservation method.

The present invention relates to methods of preserving objects comprising the pigment Prussian blue

Museums and galleries have a continuing need to preserve a growing number of historic objects, as well as contemporary and ephemeral objects.

In addition, to improve public access it is desirable for museums and galleries to be able to display objects for longer time periods than are recommended for preservation purposes at present.

The majority of museum and gallery objects are of a composite nature, meaning that they include a number of different materials. For example, a traditional watercolour painting will include the paper, probably sized with gelatine as most historic papers are, and a range of watercolour colorants each including a different pigment, or combination of pigments, to produce the required colour. The different materials present in a composite object will likely all have different sensitivities to light and other environmental factors. In general, organic materials are more sensitive to light and other environmental factors than inorganic ones, but as will be appreciated, a large number of composite objects will contain both organic and inorganic materials. The presence of different materials in composite objects presents problems when ascertaining the ideal storage and/or display environment for the object.

The vast majority of organic materials used in museum and gallery objects degrade by photo-oxidation on exposure to oxygen and light. Among these materials are many organic dyes and pigments, polymers including rubber and paper.

In Ageing and stabilisation of paper (Edited by Matija Strli\check{c} and Jana Kolar, 2005, section 9.4), a method of measuring the photo-oxidation of cellulose is discussed. Since photo-oxidation of cellulose leads to the gradual depolymerisation of cellulose, it can be evaluated using size exclusion chromatography (SEC) or viscometry. SEC is a chromatographic method in which materials are analysed based on their molecular weights. Therefore, as the cellulose polymers degrade, a size exclusion chromatograph shows a reduction in the peak corresponding to the cellulose polymer molecular weight.

To reduce the photo-oxidation of organic materials, storage in anoxic conditions (total lack of oxygen) for preservation purposes has been mentioned sporadically for over a century. However, some materials are not stable under anoxic conditions and it is therefore generally considered unwise to store composite objects which may comprise these unstable materials under anoxic conditions.

The pigment Prussian blue is known to be unstable under anoxic conditions. Prussian blue has the chemical formula M^{2r}Fe^{(III)}₂ᵣFe^{(II)}₂ᵣ(CN)₆ᵣ.n.H₂O, where M is either an aluminium (Al³⁺), an iron (Fe^{(III)} or Fe^{(II)}), a potassium (K⁺), an ammonium (NH₄⁺) or a sodium (Na⁺) ion, r=0.5 for single-valence M ions such as K⁺, Na⁺, r=1 for double-valence M ions such as Fe^{(II)}, and r=1.5 for triple-valence ions such as Al³⁺ and Fe^{(III)}. n=14-16. Prussian blue is phototropic, meaning that it loses colour when exposed to light (fading) and regains its colour again in the dark (reversion). Under anoxic conditions, the fading of Prussian blue is worse, as demonstrated by Chevreul in 1837 when he compared samples of textile dyes made from Prussian blue in vacuo and in normal air.

It is thought that the fading of Prussian blue occurs through the reduction of Fe^{(III)} to Fe^{(II)}, which is a reversible reaction (Kirby, J. and Saunders, D. 2004. Fading and colour change of Prussian blue, National Gallery Technical Bulletin 25:73-99).

Prussian blue was invented c.1709, and has been detected in paintings from c.1725. Prussian blue has been used by many cultures since the nineteenth century, for example it has been documented in Japanese prints and in Chinese, Indian and other south-east Asian artworks. Prussian blue has also been used in western Europe from the eighteenth century, in both aqueous and oil-based media. In addition, Prussian blue was used as a textile dye between 1811 and the late nineteenth century, and as an oil-based printing ink from the very beginning of the nineteenth century until at least the mid-twentieth century.

One of the earliest copying processes was the cyanotype process, used for copying large-scale architectural and engineering drawings, for duplicating scarce or ephemeral herbarium and other scientific collections, and as a potential recording medium for images obtained by astronomers. The process was in regular use just after its invention in 1842, and then was revived in the 1870s. It was the commonest office copying process until the 1950s, and its former prevalence is reflected today in the English language as the term ‘blueprint’. Prussian blue is the colorant formed during the process.

This exceptionally wide usage of Prussian blue ensures that it may be present in many museum and gallery objects and shows the continued need to develop environments in which objects containing it can be stored or displayed without degradation. Therefore, there is a continuing need for the development of an atmosphere suitable for preserving an object comprising Prussian blue.

An object of the present invention is to provide an improved method for the preservation of an object comprising Prussian blue.

A further object of the present invention is to provide storage and/or display cases in which an object comprising Prussian blue can be preserved.

The present invention therefore provides a method of preserving an object comprising Prussian blue pigment, said method comprising the step of placing the object in an atmosphere comprising from 2 to 15% oxygen.

The present invention further provides the use of an atmosphere comprising from 2 to 15% oxygen for the preservation of an object comprising Prussian blue pigment.

The present invention further provides a storage and/or display case for an object comprising Prussian blue pigment, said case containing an atmosphere comprising from 2 to 15% oxygen.

The term “hypoxic” means a deficiency in oxygen in comparison to the ambient atmosphere which has an oxygen concentration of 21% by volume. This covers any atmosphere with an oxygen content which is lower than 21% by volume. An atmosphere with a total lack of oxygen is termed “anoxic”. Therefore, the atmospheres of the present invention, containing from 2 to 15% oxygen, may be called “hypoxic atmospheres”.

The object comprising Prussian blue pigment may also comprises a polysaccharide-based medium. Examples of traditional polysaccharide-based media include gum arabic, gum tragacanth, gum sarcocolla and cherry gum.

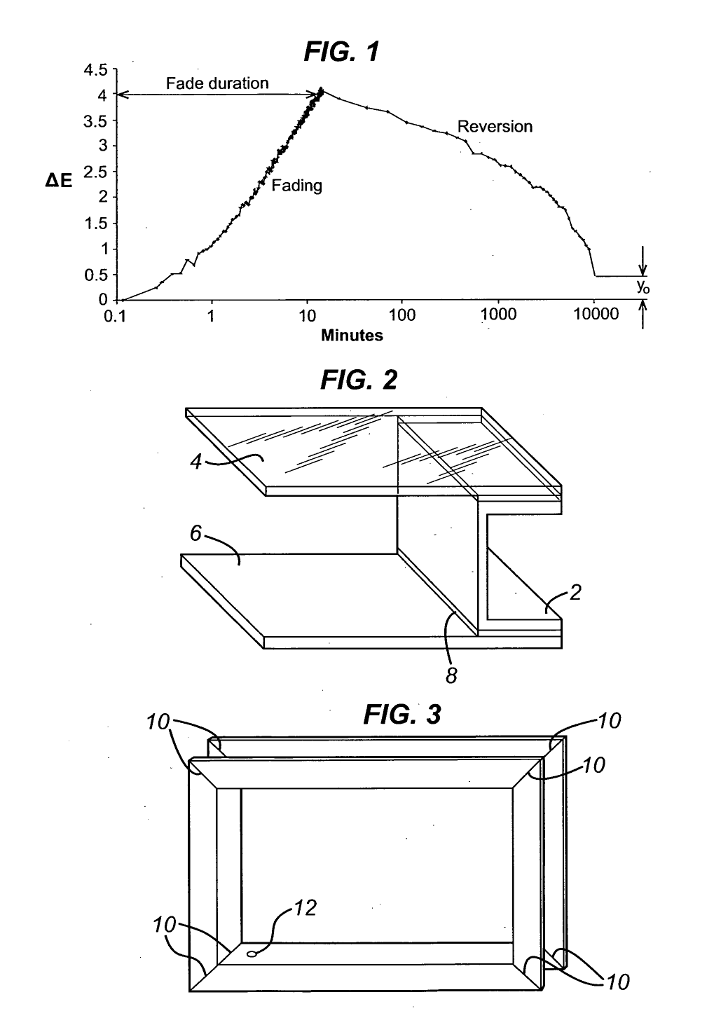

As mentioned above, Prussian blue loses its colour (or fades) due to light exposure, and regains its colour (or undergoes reversion) in the dark. This behaviour can be seen in FIG. 1 which shows the colour change of Prussian blue pigment relative to the original colour (ΔE) during fading and reversion in air.

The data in FIG. 1, and all the other fading and reversion data herein, were obtained using the microfadometer apparatus described in Lerwill et al, ePreservation Science, 5:17-28. During the fading period, the microfadometer uses a fibre optic to illuminate the sample with visible light at approximately 500 watts per square centimetre and 7 million lux. The wavelength of the visible light is from 400-700 nm. This illumination serves to fade the Prussian blue in the sample. The fade duration is the length of time for which the Prussian blue sample is exposed to the light. During the reversion period, the sample is not exposed to any light by the microfadometer, and therefore undergoes reversion to regain its colour.

Without wishing to be bound by theory, the inventors believe that the photo-fading of Prussian blue is caused by the reduction of Fe^{(III)} to Fe^{(II)} through a photo-initiated pathway in the presence of suitable reducing species, whereas the reversion is caused by the oxidation of Fe^{(II)} to Fe^{(III)} and is dependent on the presence of suitable oxidising species. However, in oxygen-containing atmospheres, Prussian blue is undergoing the process of reversion continuously, irrespective of the light conditions. Therefore, when the Prussian blue is exposed to light, whilst still in the oxygen-containing atmosphere, both the reduction and oxidation reactions occur simultaneously. When the rate of the reduction reaction, which is dependent on the intensity of incident light, exceeds the rate of the oxidation reaction, the Prussian blue will be observed to fade. When the light source is removed, the rate of the reduction reaction will fall and the Prussian blue will be seen to undergo reversion as the oxidation reaction continues.

As shown in FIG. 1, as the Prussian blue pigment fades, ΔE increases, whereas during reversion of the Prussian blue pigment, ΔE decreases. However, the reversion curve of FIG. 1 does not reach zero, indicating that the Prussian blue pigment does not fully revert to its original colour. The final colour change of the pigment, following reversion, compared to the original colour prior to fading is given by y₀. y₀ would be zero for total reversion.

However, y₀ is generally non-zero leading to irreversible photodegradation. As used herein, “irreversible photodegradation” is a measure of the colour change (or ΔE) of the Prussian blue pigment following a fading and reversion cycle. The total irreversible degradation may be measured for a number of fading and reversion cycles as the sum of the y₀ values for each fading and reversion cycle.

Theoretically, if y₀ is zero the Prussian blue pigment will have reverted to its original colour during reversion. Therefore, when y₀ is zero, the Prussian blue pigment will undergo no irreversible phototropic degradation. In contrast, if y₀ is non-zero, each reversion will not fully revert the Prussian blue pigment to its original colour (the colour prior to the previous fading curve). Therefore, when y₀ is non-zero, the Prussian blue pigment will undergo irreversible phototropic degradation. It is clear that the greater the value of y₀, the worse the irreversible degradation.

In addition to the irreversible degradation discussed above, the amount of reversible phototropic degradation is also a problem for Prussian blue.

As used herein, “reversible phototropic degradation” is a measure of the colour change (or ΔE) of the Prussian blue pigment during a single fading cycle.

The hypoxic atmosphere of the present invention is advantageous for the storage and/or display of objects comprising Prussian blue as it provides a low y₀ for Prussian blue, thereby reducing irreversible degradation of the pigment.

In addition, the hypoxic atmosphere of the present invention is deficient in oxygen which inhibits the degradation of other organic materials which degrade through photo-oxidation. Therefore, the hypoxic atmosphere of the present invention may be used to store and/or display composite objects comprising both Prussian blue and other organic materials which degrade through photo-oxidation. This is particularly useful for artworks on paper which comprise Prussian blue, as paper is known to degrade through photo-oxidation.

Furthermore, the hypoxic atmosphere of the present invention reduces the colour change of the Prussian blue pigment during a single fading cycle, thereby reducing the reversible phototropic degradation of Prussian blue.

In one embodiment, the atmosphere comprises from 3 to 15% oxygen. In a further embodiment, the atmosphere contains from 4 to 14% oxygen. In a further embodiment the atmosphere comprises from 5 to 12% oxygen. In a still further embodiment the atmosphere comprises from 5 to 10% oxygen. In a still further embodiment the atmosphere comprises from 5 to 8% oxygen. In a still further embodiment the atmosphere comprises from 5 to 6% oxygen.

In embodiments of the present invention the atmosphere comprises greater than or equal to 2%, 3%, 4%, 5%, 6%, 7% or 8% oxygen. In a further embodiment, the atmosphere comprises less than or equal to 15%, 14%, 13%, 12%, 11% or 10% oxygen. Further embodiments of the present invention comprise combinations of the aforementioned embodiments.

Any percentages mentioned herein when referring to the atmosphere refer to percentage by volume of a gas in the atmosphere in which the object is placed.

It will be appreciated that reference to comprising from X to Y % of a gas means that the % by volume of the gas in the atmosphere is in the range X to Y %.

In one embodiment, the atmosphere consists of oxygen and a further gas, which further gas is selected from an inert gas, nitrogen or mixtures thereof. The inert gas may be helium, neon, argon, xenon, or mixtures thereof. In one embodiment, the further gas is argon, nitrogen, helium, xenon or mixtures thereof. In a further embodiment, the further gas is argon, nitrogen, helium or mixtures thereof. In a still further embodiment, the further gas is argon, nitrogen or mixtures thereof.

In one embodiment, the atmosphere has a pressure of from 530 to 1140 Torr. In a further embodiment, the atmosphere has a pressure of 200 Ton to 1140 Torr.

In one embodiment, the temperature of the atmosphere is maintained at from 10 to 30° C. In another embodiment, the temperature of the atmosphere is maintained at room temperature (from 22 to 28° C.).

The atmosphere and object may be contained in a storage and/or display case. As used herein, the term “storage and/or display case” includes storage cases, display cases and cases which may be used for both storage and display. An advantage of using the same case for both display and storage of the object is that the object may remain in the same case for a longer period of time reducing its exposure to damaging pollutants and gases in the ambient atmosphere. The object may remain in one or other of these cases for up to several years (e.g. 10 years) without any significant irreversible degradation of the Prussian blue pigment.

The storage and/or display case comprises a gas-tight container to contain the object. Any suitable gas-tight container may be used. The atmosphere in the case is set according to the limitations of the present invention. The case may be designed to be fitted into a traditional display frame or housing to be presented indistinguishably from other framed objects.

The storage and/or display case may be used to store any museum or gallery object. In one embodiment, the storage and/or display case may be used for a range of works of art on paper, canvas, cotton, linen, wood, board, other cellulosic materials or combinations thereof, for example monochrome drawings, prints, traditional watercolour paintings and contemporary digital prints and photographs. These are typically thin objects (˜0.1 to 0.5 mm thick) with relatively flat surfaces but with a wide range of different heights and widths. Works of art on paper are often fixed reversibly to a secondary support of archivally-stable card (conservation board), and have a hinged mount of similar material on top, with a window cut to reveal the entire surface of the artwork, with total thickness of about 4.5 mm. This entire composition, i.e. the work, secondary support, hinged mount and window may be kept in the storage and/or display case.

The display and/or storage case may be constructed of any suitable material, for example a metal such as aluminium, stainless steel, titanium and mixtures and alloys thereof. In one embodiment, the display and/or storage case may be constructed of aluminium, stainless steel or mixtures or alloys thereof. If the case is a display case, it is preferred that it comprises at least one transparent surface to allow the object to be viewed. The at least one transparent surface may be present if the case is a storage case, although this is not required. The transparent surface is preferably glass.

The composition of the atmosphere within the storage and/or display case may be monitored passively through a transparent area in the storage and/or display case without disturbing the atmosphere. This transparent area may be the transparent surface. Alternatively, this transparent area may be a small area in one side of a storage and/or display case through which the composition of the atmosphere in which the object is stored may be monitored. An oxygen sensor, for example those manufactures by Gas Sensor Solutions Ltd or by Ocean Optics Ltd, may be used to monitor the concentration of oxygen in the atmosphere.

The display and/or storage case is preferably sealed with a flexible adhesive with long-term crack resistance and low gas permeability, e.g. a butyl rubber mastic tape.

All the materials used to form the display and/or storage case must have very low permeability to oxygen, nitrogen, and argon, such that the atmosphere within the case may be maintained at the required composition.

A means for allowing the removal and/or replacement of gases in the atmosphere within a sealed storage and/or display case, without opening it or disturbing the object therein, may be fitted to the case. This means may be a gas-port or a sealable copper pipe. The copper pipe may be sealed by crimping and soldering.

For an object that might off-gas, the storage and/or display case may contain an absorber and/or pH buffering material to maintain the desired atmosphere.

Particularly useful absorbers are those which absorb pollutants and/or the degradation components of organic materials (e.g. cellulosic and lignin-containing papers with gelatine size, polysaccharide media, pigments and extenders present as components of a watercolour, acetic/nitric acids from cellulosic plastics and formic acid from wood components in the object). Examples of suitable absorbers are silica gel, activated carbon and zeolites.

In one embodiment, the pH buffering material maintains the pH of the atmosphere in the range of from 5 to 9. In a further embodiment, the pH buffering material maintains the pH of the atmosphere in the range of from 6 to 8. In one embodiment, the pH buffering material is an alkaline reserve. In a further embodiment, the pH buffering material may be the absorber mentioned above.

It may be preferable to pre-treat the object to be placed in the storage and/or display case to dry them and thereby regulate the moisture content of the object inside the case.

The present invention is now described, by way of illustration only, with reference to the accompanying drawings, in which:

FIG. 1 shows a combined fading and reversion curve for Turner's Prussian blue ground in gum arabic, painted onto reconstructed 19th century paper in air;

FIG. 2 shows a possible construction method for the storage and/or display case;

FIG. 3 shows a supporting frame for the storage and/or display case;

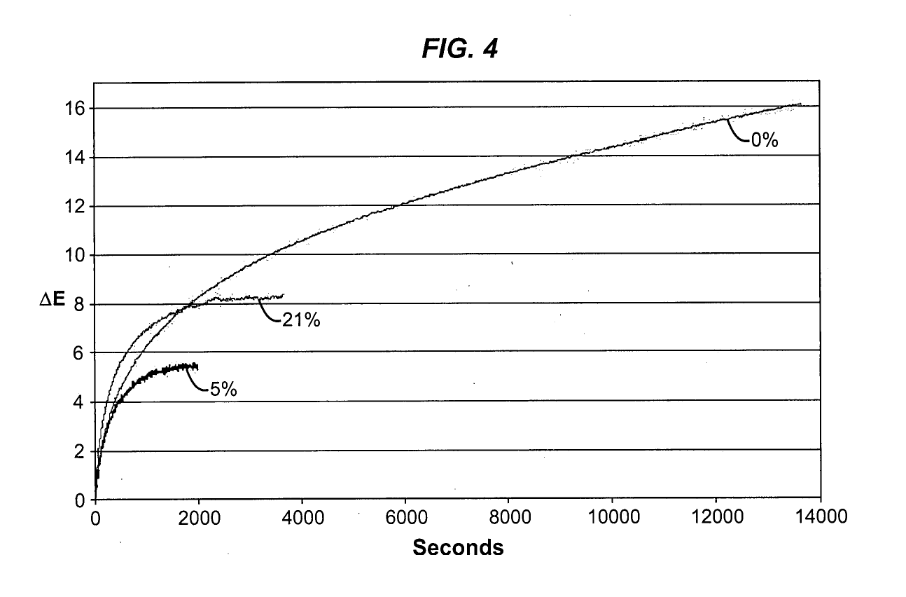

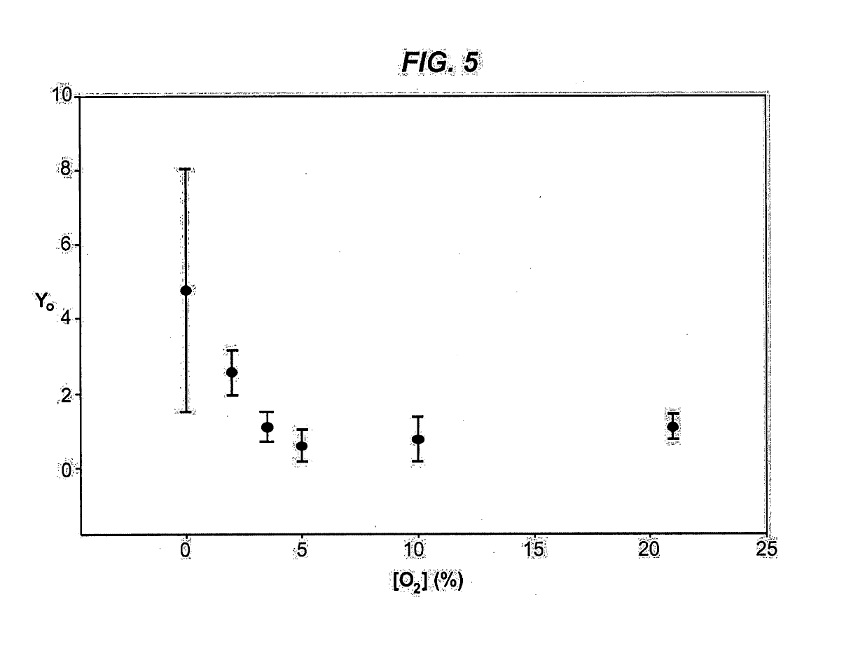

FIG. 4 shows the relationship between ΔE and fade time for different oxygen concentrations for Turner's Prussian blue ground in gum arabic, painted onto reconstructed 19th century paper;

FIG. 5 shows the dependence of y₀ on oxygen concentration for Turner's Prussian blue ground in gum arabic, painted onto reconstructed 19th century paper;

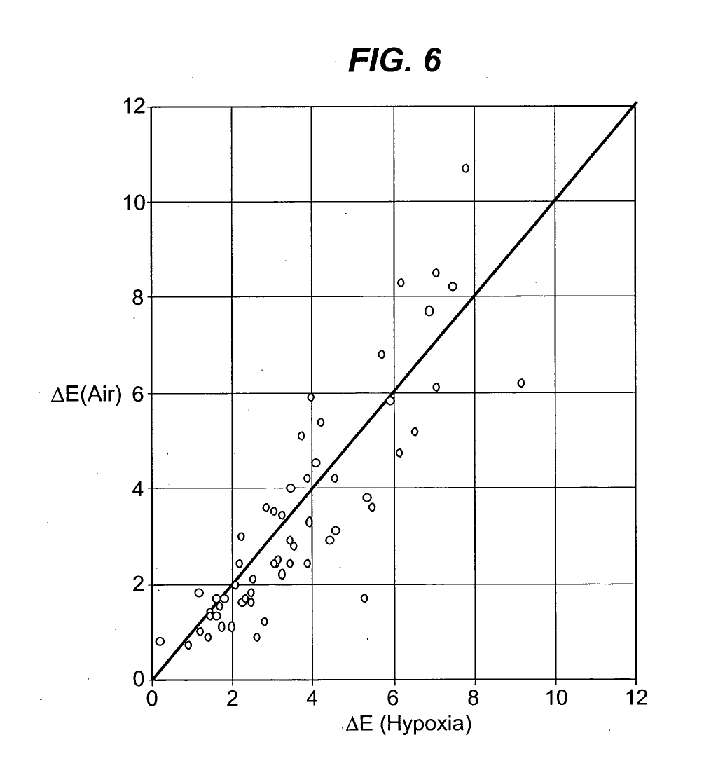

FIG. 6 shows ΔE immediately after microfadometry, i.e. before reversion could take place, in room atmosphere against ΔE immediately after microfadometry in 5% oxygen for 63 samples of Prussian blue obtained from several collections of traditional watercolour pigments, ground in gum arabic, painted onto reconstructed 19th century paper.

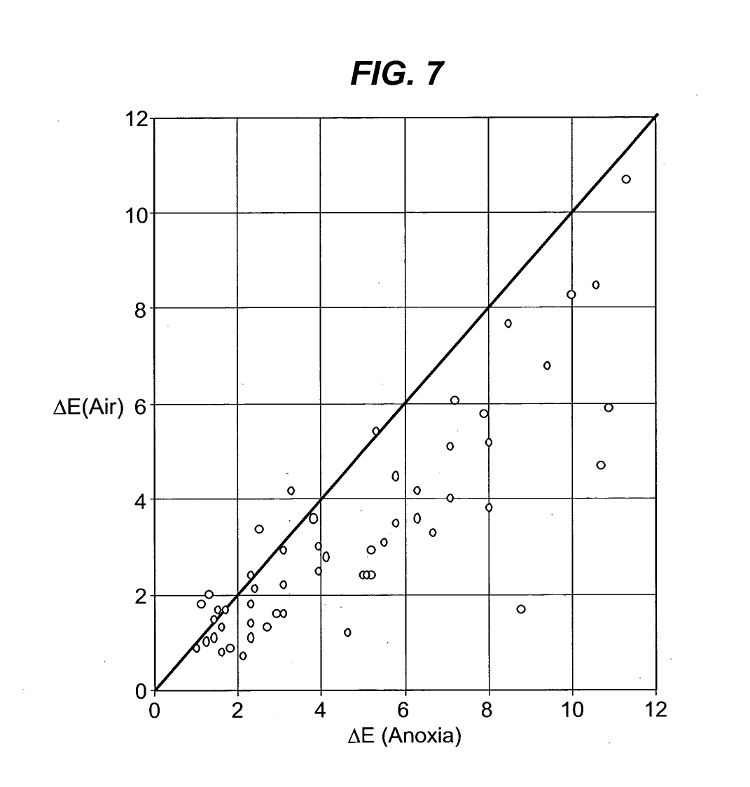

FIG. 7 shows ΔE immediately after microfadometry, i.e. before reversion could take place, in room atmosphere against ΔE immediately after microfadometry in 0% oxygen for 63 samples of Prussian blue obtained from several collections of traditional watercolour pigments, ground in gum arabic, painted onto reconstructed 19th century paper.

FIG. 2 shows a possible construction method for the storage and/or display case. The case is constructed from a horizontal U-section aluminium extrusion (2) to form the four sides and two sheets of material with low gas permeability to act as front (4) and back (6). The case has at least one transparent surface (4) so that the contents are visible on display. The extrusion, from and back are held together with a flexible adhesive (8).

The aluminium extrusion may be cut to any length, depending on the required height and width dimensions of the case. The ends are cut diagonally at 45 degrees and are preferably joined by tungsten inert gas (TIG) welding to make a four sided frame structure with mitred corners (10), see FIG. 3. The frame structure may also comprise a gas port (12).

The invention is further illustrated by the following examples. It will be appreciated that the examples are for illustrative purposes only and are not intended to limit the invention as described above. Modification of detail may be made without departing from the scope of the invention.

### EXAMPLES

In the following examples, [O₂] is the oxygen concentration as percentage by volume of total gas content.

All error bars represent one standard deviation about the average of the relevant data point.

### Example 1

### Preparations

### Reconstructed 19th Century Paper

The paper used in the following examples attempts to reproduce a white, high linen content, wove paper typical of that produced in the early to mid 19th century.

Paper was produced from pulp which was 60 wt % linen and 40 wt % cotton. The internal size of the paper was made from pharmaceutical-grade gelatine. The paper was also externally sized with the same gelatine. The sizing is important with respect to workability, fading of pigments, and chemical properties.

The paper was pressed between felts to give a ‘rough’ finish. The texture was wove, not laid, to emulate the papers used by most early to mid-nineteenth-century artists (e.g. Turner and Blake).

### Prussian Blue Pigment

Unless otherwise stated, all measurements were carried out using a sample of dry powder pigment consisting of Prussian blue from Turner's studio. This pigment was manufactured prior to his death in 1851 and was shown by analysis to be of the traditional type made from animal-based products, consistent with that found in many of his paper-based artworks. Hereafter this pigment will be called Turner's Prussian blue (TTB 6).

### Watercolour Paint Samples

TTB 6 was ground under deionised water and gum arabic on a glass slab with a glass muller. The resulting slurry was transferred to a Petri dish and allowed to dry for later use. This formed pre-prepared TTB 6 watercolour paint.

### Example 2

### Microfadometry Investigation of Prussian Blue

Flakes of the pre-prepared TTB 6 watercolour paint were each dissolved in a minimum of deionised water. Each resulting wash was then further diluted with deionised water on a ceramic palette to yield a light tone wash with more than 50% reflectance.

### Microfadometry Experimental Setup

As mentioned previously, fading and reversion data provided herein were obtained using the microfadometer apparatus described in Lerwill et al, ePreservation Science, 5:17-28.

Samples of the wash were then applied to a number of squares of the reconstructed 19th century paper. The prepared squares were cut and mounted to fit into flow cells constructed from 5×10 aluminium rectangular sections and plain glass 2 mm thick. All microfading measurements were made through this glass. The cells were sealed with a gas-tight, butyl rubber mastic and laminated low-reflecting glass was used to create the windows. The cells were fitted with two vacuum rated Festo ball valves and either left with room atmosphere or purged with gasses of certified purity and composition supplied by BOC: zero oxygen grade argon, zero oxygen grade nitrogen, 2% oxygen in nitrogen, 3% oxygen in nitrogen, 5% oxygen in nitrogen, or 10% oxygen in nitrogen. The oxygen concentration was confirmed prior to analysis by fluorimetry with the GSS mark II oxygen sensor.

This microfadometry technique was used to fade the Prussian blue in the samples through the plain glass of the flow cells in order to study its reversion. During the fading period, the microfadometer uses a fibre optic to illuminate the sample with visible light at approximately 500 watts per square centimetre and 7 million lux. The wavelength of the visible light is from 400-700 nm. This illumination serves to fade the Prussian blue in the sample. The fade duration is the length of time for which the Prussian blue sample is exposed to the light. During the reversion period, the sample remains in the flow cell but is not exposed to any light by the microfadometer, and therefore undergoes reversion to regain its colour.

Fade durations of 15 minutes, 1 hour, 3 hours, and 15 hours were used following which time the microfadometer apparatus was switched off to allow the faded samples to undergo reversion. It was not necessary to use the same fade duration for each experiment because there is no relationship between y₀ and fade duration.

### Influence of Oxygen Concentration on ΔE

The influence of oxygen concentration on ΔE during fading of Prussian blue was investigated.

The oxygen concentrations of 0%, 5% or 21% were created by flushing the flow cells containing the reconstructed 19th century paper samples with the Prussian blue wash applied with a gas of the desired oxygen levels (the remainder of the gas being nitrogen). In the case of 21% the pigment was tested in the same type of flow cell, but with the valves open to the room atmosphere. The data from these experiments is shown in FIG. 4.

FIG. 4 shows that in the atmospheres with an oxygen concentration of 5% and 21%, the rate of change of ΔE with time (i.e. the gradient of the curve) reduces dramatically after approximately 2000 seconds, to the extent that the ΔE plateau for these oxygen concentrations. In contrast, ΔE under the anoxic conditions (0% oxygen) is still rising after 13000 seconds. These data show that in a single fading cycle, anoxic conditions result in a larger colour change for the Prussian blue at long times thereby increasing the reversible phototropic degradation.

Influence of Oxygen Concentration on y₀

The influence of oxygen concentration on y₀ of Prussian blue was investigated.

The oxygen concentrations of 0%, 2%, 3%, 5%, 10% or 21% were created by flushing the flow cells containing the reconstructed 19th century paper samples with the Prussian blue wash applied with a gas of the desired oxygen levels (the remainder of the gas being nitrogen). In the case of 21% the pigment was tested in the same type of flow cell, but with the valves open to the room atmosphere. The data from these experiments is shown in FIG. 5.

The data in FIG. 5 show that at 10% and 5% oxygen, y₀ is, within error, identical to that under ambient atmosphere oxygen concentrations (i.e. 21% oxygen). In contrast, at 0% and 2% oxygen, y₀ is greater than under ambient atmosphere oxygen concentrations. This indicates that the deleterious effects of anoxic conditions on Prussian blue may start to become apparent at oxygen concentrations below around 3%. Therefore, objects comprising Prussian blue will have increased y₀ values, and therefore undergo increased irreversible degradation, in atmospheres having oxygen concentrations below around 3%.

These data demonstrate that storage and/or display of objects comprising Prussian blue under the hypoxic conditions of the present invention both minimises irreversible degradation of Prussian blue and reduces the effects of photo-oxidative degradation of other organic material which may be present, shown in example 5.

### Testing of Further Prussian Blue Samples

63 samples of Prussian blue obtained from several collections of traditional watercolour pigments were prepared in the same manner as described for TTB 6 in example 1.

Flakes of the 63 pre-prepared Prussian blue watercolour paints were each dissolved in a minimum of deionised water. Each resulting wash was then further diluted with deionised water on a ceramic palette to yield a light tone wash with more than 50% reflectance.

The oxygen concentrations of 0%, 5% or 21% were created in the microfadometer device by flushing the flow cells containing the reconstructed 19th century paper samples with the Prussian blue wash applied with a gas of the desired oxygen levels (the remainder of the gas being nitrogen). In the case of 21% the pigment was tested in the same type of flow cell, but with the valves open to the room atmosphere.

FIG. 6 shows ΔE immediately after microfadometry in room atmosphere against ΔE immediately after microfadometry in 5% oxygen for the 63 samples of Prussian blue. FIG. 7 shows ΔE immediately after microfadometry in room atmosphere against ΔE immediately after microfadometry in 0% oxygen for the 63 samples of Prussian blue. A comparison of these two figures shows the clear trend that Prussian blue pigments fade less in 5% oxygen (hypoxic conditions) compared to 0% oxygen (anoxic conditions). These data show that the present invention is applicable across the entire field of Prussian blue pigments.

1. A method of preserving an object comprising Prussian blue pigment, said method comprising the step of placing the object in an atmosphere comprising from 2 to 15% oxygen.

2. The method of claim 1, wherein the atmosphere comprises from 5 to 6% oxygen.

3. The method of claim 1, wherein the atmosphere comprises oxygen and a further gas, which further gas is selected from an inert gas, nitrogen or mixtures thereof.

4. The method of claim 1, wherein the object comprises a polysaccharide-based medium.

5. (canceled)

6. A storage and/or display case for an object comprising Prussian blue pigment, said case containing an atmosphere comprising from 2 to 15% oxygen.

7. The case of claim 6, additionally containing an absorber.

8. The case of claim 6, additionally containing a pH buffering material.
